(19) United States
(12) Patent Application Publication
(10) Pub. No.: US 2016/0337249 A1
(43) Pub. Date: Nov. 17, 2016

(54) COMMUNICATIONS NETWORK, DEVICE, AND CONTROL METHOD

(71) Applicant: Huawei Technologies Co., Ltd., Shenzhen (CN)

(72) Inventors: Wei ZHANG, Shanghai (CN); Wei ZHANG, Shanghai (CN); Chenghui PENG, Munich (DE)

(21) Appl. No.: 15/222,253

(22) Filed: Jul. 28, 2016

Related U.S. Application Data
(63) Continuation of application No. PCT/CN2014/071807, filed on Jan. 29, 2014.

(51) Int. Cl. H04L 12/813; H04L 12/851; H04L 29/08

(52) U.S. Cl. CPC H04L 47/20; H04L 67/10; H04L 69/326; H04L 47/2483

(57) ABSTRACT

Provides a communications network, a device, and a control method. The communications network includes a network controller NC, at least one entry node EN, and at least one function node FN. The NC is configured to receive, in a centralized manner, a decision request triggered by a trigger condition or sent by a processing node, where the decision request carries identification information of a data stream, determine, according to the identification information of the data stream and processing capability information of the processing node that is stored in the NC, a processing manner and path information that are of the data stream corresponding to the identification information, and send the determined processing manner and path information to one of or a combination of the EN and the FN, so that the one of or combination of the EN and the FN processes the data stream according to the processing manner.

### CROSS-REFERENCE TO RELATED APPLICATIONS

This application is a continuation of International Patent Application No. PCT/CN2014/071807, filed on Jan. 29, 2014, which is hereby incorporated by reference in its entirety.

### TECHNICAL FIELD

The present invention relates to the field of communications technologies, and in particular, to a communications network, a device, and a control method.

### BACKGROUND

With development of an information technology (IT for short), a hardware platform based on a general-purpose central processing unit (CPU for short), such as X86, Arm, or Mips of the IT, is applied to wider fields, and even extends to the field of communications technology (CT for short). Using a common platform in the CT field, for a communications vendor, can shorten a development cycle and reduce product difficulty, thereby reducing development costs. For operators using communications devices, product procurement prices can also be lowered and maintenance costs can also be reduced.

To use the common platform in the CT field, currently a new-type network innovation architecture a software-defined networking (SDN for short) idea is put forward in the communications industry. The SDN is mainly characterized in that, a control plane is separated from a data plane, control planes of different network devices are centralized, and centralized control is performed by a centralized control device. Data planes of the network devices are open to the centralized control device, achieving, by means of the centralized control, an objective of improving overall resource utilization.

A concept of the SDN is applied to an IP transport network, and is embodied as centralized control over data stream processing in the transport network. In the new-type SDN, how to implement control over an SDN network becomes a problem to be urgently resolved in the SDN.

### SUMMARY

Embodiments of the present invention provide a communications network, a device, and a control method, which are used to resolve a problem of how to control, when a new type of SDN is constructed, data stream processing.

According to a first aspect, an embodiment of the present invention provides a communications network, including: a network controller NC, at least one entry node EN, and at least one function node FN, where

the NC is configured to receive, in a centralized manner, a decision request triggered by a trigger condition or sent by a processing node, where the decision request carries identification information of a data stream, determine, according to the identification information of the data stream and processing capability information of the processing node that is stored in the NC, a processing manner and path information that are of the data stream corresponding to the identification information, and send the determined processing manner and path information to one of or a combination of the entry node EN and the function node FN, so that the one of or combination of the entry node EN and the function node FN processes the data stream according to the processing manner.

According to a second aspect, an embodiment of the present invention provides a network control device, including: a processor, a memory, and at least one communications port, where

the communications port is configured to communicate with an external device;

the memory is configured to store a computer program instruction; and

the processor is coupled to the memory, and is configured to invoke the computer program instruction stored in the memory, so as to receive, in a centralized manner, a decision request triggered by a trigger condition or sent by a processing node, where the decision request carries identification information of a data stream, to determine, according to the identification information of the data stream and processing capability information of a node that is stored in the NC, a processing manner and path information that are of the data stream corresponding to the identification information, and to send the determined processing manner and path information, so that the processing node indicated by the path information processes the data stream according to the processing manner.

According to a third aspect, an embodiment of the present invention provides a network marking device, including: a processor, a memory, and at least one communications port, where

the communications port is configured to communicate with an external device;

the memory is configured to store a computer program instruction; and

the processor is coupled to the memory, and is configured to invoke the computer program instruction stored in the memory, so as to add, according to received identification information, which is sent by a network control device, of a data stream, and a processing manner and path information that are of the data stream corresponding to the identification information, a corresponding marker to the data stream, and to send marked data.

According to a fourth aspect, an embodiment of the present invention provides a network processing device, including: a processor, a memory, and at least one communications port, where

the communications port is configured to communicate with an external device;

the memory is configured to store a computer program instruction;

the processor is coupled to the memory, and is configured to invoke the computer program instruction stored in the memory, so as to extract, from a marked data stream, a processing policy and a processing parameter that correspond to information about the network processing device, or so as to receive identification information, which is sent by a network control device, of a data stream, a corresponding processing policy and a corresponding processing parameter, and to process the data stream according to the processing policy and the processing parameter; and

the memory is further configured to store the identification information of the data stream, the corresponding processing policy and the corresponding processing parameter.

According to a fifth aspect, an embodiment of the present invention provides a communications network control method, including:

receiving, by a network controller NC, in a centralized manner, a decision request triggered by a trigger condition or sent by a processing node, where the decision request carries identification information of a data stream;

determining, by the NC according to the identification information of the data stream and processing capability information of the processing node that is stored in the NC, a processing manner and path information that are of the data stream corresponding to the identification information; and

sending, by the NC, the determined processing manner and path information, so that the processing node indicated by the path information processes the data stream according to the processing manner.

By means of a communications network, a device, and a control method that are provided in the embodiments of the present invention, an NC receives, in a centralized manner, a decision request, determines, in the centralized manner, a processing manner and path information that are of a data stream according to processing capabilities of processing nodes on the communications network, and controls, in the centralized manner, an entry node and/or a function node to process data, which can optimize a data stream processing procedure to the greatest extent, enhance flexibility of the network, and increase network resource utilization.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description show some embodiments of the present invention, and a person of ordinary skill in the art may still derive other drawings from these accompanying drawings without creative efforts.

FIG. 1 is a schematic structural diagram of an embodiment of a communications network according to an embodiment of the present invention;

FIG. 2 is a schematic structural diagram of an embodiment of a network control device according to an embodiment of the present invention;

FIG. 3 is a schematic structural diagram of an embodiment of a network marking device according to an embodiment of the present invention;

FIG. 4 is a schematic structural diagram of an embodiment of a network processing device according to an embodiment of the present invention;

FIG. 5 is a schematic flowchart of Embodiment 1 of a communications network control method according to an embodiment of the present invention;

FIG. 6 is a schematic flowchart of Embodiment 2 of a communications network control method according to an embodiment of the present invention;

FIG. 7 is a schematic flowchart of Embodiment 3 of a communications network control method according to an embodiment of the present invention;

FIG. 8 is a schematic flowchart of Embodiment 4 of a communications network control method according to an embodiment of the present invention; and

FIG. 9 is a schematic flowchart of Embodiment 5 of a communications network control method according to an embodiment of the present invention.

### DESCRIPTION OF EMBODIMENTS

To make the objectives, technical solutions, and advantages of the embodiments of the present invention clearer, the following clearly and completely describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

A communications network control method provided in the embodiments of the present invention applies to various wireless communications networks, for example, current 2G, 3G, and 4G communications networks and a next-generation wireless communications network, for example, a Global System for Mobile communications network (GSM, Global System for Mobile communications), a Code Division Multiple Access (CDMA, Code Division Multiple Access) network, a Time Division Multiple Access (TDMA) network, a Wideband Code Division Multiple Access (WCDMA) network, a Frequency Division Multiple Access (FDMA) network, an Orthogonal Frequency-Division Multiple Access (OFDMA) network, a single-carrier FDMA (SC-FDMA) network, a General Packet Radio Service (GPRS) network, a Long Term Evolution (LTE) network, and other wireless communications networks of this type.

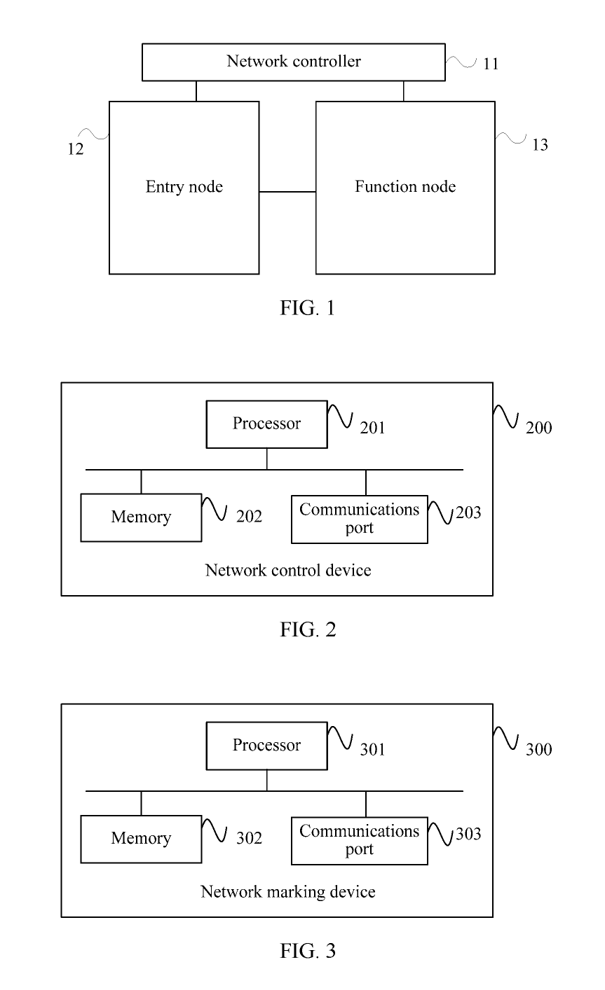

FIG. 1 is a schematic structural diagram of an embodiment of a communications network according to an embodiment of the present invention. As shown in FIG. 1, the communications network includes a network controller (NC for short) 11, at least one entry node (EN for short) 12, and at least one function node (FN for short) 13.

The NC is configured to receive, in a centralized manner, a decision request triggered by a trigger condition or sent by a processing node, where the decision request carries identification information of a data stream, determine, according to the identification information of the data stream and processing capability information of the processing node that is stored in the NC, a processing manner and path information that are of the data stream corresponding to the identification information, and send the determined processing manner and path information to one of or a combination of the entry node EN 12 and the function node FN 13, so that the one of or combination of the entry node EN 12 and the function node FN 13 processes the data stream according to the processing manner.

Specifically, the communications network provided in this embodiment is an SDN network, and as a unique control-plane device on the SDN network, the NC is responsible for centralized processing for a signaling plane and centralized control for a user plane for the entire SDN network. In the present invention, the NC is mainly responsible for deciding processing policies and processing parameters on nodes on a user data path according to acquired characteristic information of a network, a user, or a service, and transmitting the processing policies and the processing parameters to a corresponding entry node and a corresponding function node.

As user-plane devices in the SDN, the EN and the FN are mainly responsible for policy execution and data forwarding. Functions of the entry node include performing data rule matching, and marking in a labeling manner. According to a label marked by the entry node, the function node on a successor data path may directly obtain the processing policy by means of an index, decide next-hop routing, or the like. On the SDN network, one EN may exist, or multiple ENs may exist. Function nodes form a function node network (FNN for short). The FNN not only has a data forwarding function of a router or a switch, but also has a data processing function. Possible specific function types include but are not limited to: decomposition of a physical-layer processing function, decomposition of a layer 2 function, decomposition of a layer 3 function, video optimization, cross stratum optimization, and the like. Each function node has functions such as calculation, storage, and bandwidth limitation. In data processing, the function nodes may have a same processing manner, or may have different processing manners. The processing manner mentioned in embodiments of the present invention includes a data stream processing method, for example, a compression manner or a compression algorithm for video compression, and further includes a data processing priority, or a specific processing parameter when a processing manner is used. The function nodes may be directly connected to each other, or may be connected by means of an IP network. Data forwarding inside the IP network may be performed in an SDN manner, or may be performed in a conventional autonomous manner.

The identification information of the data stream may be based on user granularity or based on service granularity. For example, if the decision request is for user access, policy change, or user movement, the identification information of the data stream carried in the decision request is based on the user granularity. If the decision request is for service creation, the identification information of the data stream carried in the decision request is based on the service granularity. If the identification information of the data stream carried in the decision request is based on the user granularity, the identification information of the data stream may include a user ID or a user IP address. If the identification information of the data stream carried in the decision request is based on a service granularity, the identification information of the data stream may include a combination of a user ID and a service identifier, or a combination of an IP address and a service identifier, which is not limited in this embodiment.

The present invention focuses on a data processing manner, and a manner for path information to be transferred in a network architecture shown in FIG. 1. The so-called processing manner refers to several fixed manners of data processing, and includes how to process data, or trigger event reporting, or the like. The processing manner and the path information may be statically configured on an entry node and/or a function node on a data path in a pre-configuration manner. However, to enhance flexibility of a system, and also to more properly utilize a network resource, and because the entire network constantly changes, the processing manner and the path information need to be updated from time to time. Therefore, it is more suitable to configure the processing policy and the processing parameter in a dynamic update manner.

In a possible implementation manner of this embodiment, the processing manner includes a processing policy and a processing parameter, and the path information includes information about the entry node EN and information about a function node network FN that the data stream needs to pass through;

the NC is specifically configured to send the information about the function node FN that the data stream corresponding to the identification information needs to pass through, the processing policy, and the processing parameter to the entry node EN;

the EN is specifically configured to add a corresponding marker to the data stream according to the information about the function node FN that the data stream needs to pass through, the processing policy, and the processing parameter, and send the marked data stream; and

the function node FN is specifically configured to extract, from the marked data stream, the processing policy and the processing parameter that correspond to the information about the function node FN, and process the data stream according to the processing policy and the processing parameter.

The so-called processing policy refers to that processing such as compression, decompression, or packaging needs to be performed on data, and the so-called processing parameter refers to a parameter that is specifically used during processing after the processing policy is selected for data processing. A value of the parameter is determined according to a specific situation.

Specifically, if a decision request received by the NC is sent by the entry node EN, or is triggered by an event, after determining a processing manner and path information, the NC may send the determined processing manner and path information to the entry node EN included in the path information, and after marking a processing policy, a processing parameter, and function node information into a data stream, the EN sends the data stream. Alternatively, after determining a processing manner and path information, the NC may further send, to the EN, information about a function node that a data stream needs to pass through, and send a processing policy and a processing parameter that are of the data stream to the FN that is passed through by the data stream.

Therefore, in another possible implementation manner of this embodiment, the processing manner includes a processing policy and a processing parameter that are of the data stream, and the path information includes information about an entry node EN and a function node FN that the data stream needs to pass through;

the NC is specifically configured to send, to the EN, the information about the function node FN that the data stream needs to pass through, and send the processing policy and the processing parameter that are of the data stream to the FN that the data stream needs to pass through;

the EN is specifically configured to add a corresponding marker to the data stream according to the information about the function node FN that the data stream needs to pass through; and

the function node FN is specifically configured to process, according to the processing policy and the processing parameter, the data stream marked with the information about the function node FN.

Alternatively, in still another possible implementation manner of this embodiment, the processing manner includes a processing policy and a processing parameter that are of the data stream, and the path information includes information about a function node FN that the data stream needs to pass through;

the NC is specifically configured to send the path information, the processing policy, and the processing parameter that are of the data stream to function nodes FN in the path information; and

the FN is specifically configured to process the data stream according to the processing policy and the processing parameter.

Specifically, if a decision request received by the NC is triggered by the FN, it is not necessary for the NC to decide information about an entry node that a data stream needs to pass through, and the NC determines only a function node that the data stream needs to pass through, a processing policy, and a processing parameter, and sends the determined processing policy and processing parameter to function nodes FN in path information; and the FNs separately process the data stream according to the processing policy and the processing parameter.

In a preferred implementation manner, before sending the processing manner and the path information to the one of or combination of the entry node EN and the function node FN, the NC is further configured to:

locally store the identification information of the data stream, the corresponding processing manner and the corresponding path information.

Specifically, to prevent the NC from repeatedly processing multiple decision requests of a same data stream, a memory may be set in the NC, to store determined identification information of the data stream, a corresponding processing manner and corresponding path information, so that when receiving a decision request again, the NC may query, according to the identification information of the data stream, for the processing manner and the path information that are stored locally. If the processing manner and the path information are found, the NC may send the processing manner and the path information; or if the processing manner and the path information are not found, the NC processes the decision request.

Accordingly, in a first implementation manner of this embodiment, the entry node EN is further configured to locally store the identification information of the data stream, the information about the function node FN that the data stream needs to pass through, the processing policy, and the processing parameter; and

after extracting, from the marked data stream, the processing policy and the processing parameter that correspond to the information about the function node FN, the function node FN is further configured to locally store the identification information of the data stream, the corresponding processing policy and the corresponding processing parameter.

In another implementation manner of this embodiment, the entry node EN is further configured to:

locally store the identification information of the data stream, the information about the function node FN that the data stream needs to pass through; and

the function node FN is further configured to locally store the identification information of the data stream, the corresponding processing policy and the corresponding processing parameter.

Specifically, the entry node EN and/or the function node FN separately locally stores the obtained processing manner and path information that are of the data stream, so that when receiving a data stream, the EN and the FN may first query, according to identification information of the data stream, whether locally there are a corresponding processing manner and corresponding path information; and if yes, may process data according to the locally stored processing manner and path information; or if not, send a decision request to the NC.

Accordingly, in another possible implementation manner of this embodiment, the EN is further configured to:

receive a data stream, where the data stream carries identification information of the data stream;

query whether locally there is path information of the data stream corresponding to the identification information of the data stream; and

if not, send a decision request to the NC, where the decision request carries the identification information of the data stream.

In still another possible implementation manner of this embodiment, the FN is further configured to:

receive a data stream, where the data stream carries identification information of the data stream;

query whether locally there is a processing manner of the data stream corresponding to the identification information of the data stream; and

if not, send a decision request to the NC, where the decision request carries the identification information of the data stream.

Specifically, that an entry node performs marking processing on a data stream includes that: the EN is specifically configured to encapsulate one of or a combination of the path information and the processing manner in a first data packet of the data stream; or the EN is specifically configured to encapsulate the one of or combination of the path information and the processing manner in a null data packet, and before sending the data stream, first send the data packet in which the one of or combination of the path information and the processing manner is encapsulated.

If the EN receives the path information and the processing manner that are of the data stream and that are sent by the NC, after receiving the data stream, the EN encapsulates the FN information, the processing policy, and the processing parameter that are in the path information in a first data packet of the data stream, in a null data packet; or if the EN receives the information, which is sent by the NC, about the function node FN that the data stream needs to pass through, after receiving the data stream, the EN encapsulates the information about the function node FN in a first data packet of the data stream, or in a null data packet. In addition, to ensure that the FN can first obtain, according to the FN information in the data packet in which the path information is encapsulated, a processing policy and a processing parameter for the FN to process the data stream. The data packet in which the processing manner and the path information are encapsulated needs to arrive before the data stream arrives at the FN. Therefore, generally the path information and the processing manner may be encapsulated in the first data packet of the data stream, or the null data packet in which the path information and the processing manner are encapsulated may be sent before the data stream arrives at the FN.

Further, the first data packet or the null data packet in which the processing manner and the path information are marked is very important, and therefore if the first data packet or the null data packet is lost, a relatively major fault is caused in a system. To prevent a packet loss, the EN is further configured to set, to a highest priority, the data packet in which the one of or combination of the path information and the processing manner is encapsulated.

The communications network provided in this embodiment is a virtualized SDN network, network devices on the network are virtualized network units for performing different functions, and the network devices cooperate with each other to form a complete communications network.

By means of the communications network provided in this embodiment, a network controller receives, in a centralized manner, a decision request, determines, in the centralized manner, a processing manner and path information that are of a data stream according to processing capabilities of processing nodes on the communications network, and controls, in the centralized manner, an entry node and/or a function node to process data, which can optimize a data stream processing procedure to the greatest extent, enhance flexibility of the network, and increase network resource utilization.

FIG. 2 is a schematic structural diagram of an embodiment of a network control device according to an embodiment of the present invention. As shown in FIG. 2, the network control device 200 includes: a processor 201, a memory 202, and at least one communications port 203.

The communications port 203 is configured to communicate with an external device; the memory 202 is configured to store a computer program instruction; and the processor 201 is coupled to the memory 202, and is configured to invoke the computer program instruction stored in the memory 202, so as to receive, in a centralized manner, a decision request triggered by a trigger condition or sent by a processing node, where the decision request carries identification information of a data stream, to determine, according to the identification information of the data stream and processing capability information of a node that is stored in the NC, a processing manner and path information that are of the data stream corresponding to the identification information, and to send the determined processing manner and path information, so that the processing node indicated by the path information processes the data stream according to the processing manner.

In a specific implementation manner of this embodiment, the processing manner includes a processing policy and a processing parameter, and the path information includes information about the entry node EN and information about a function node FN that the data stream needs to pass through; and

the processor is specifically configured to send the information about the function node FN that the data stream corresponding to the identification information needs to pass through, the processing policy, and the processing parameter to the entry node EN, so that the EN adds a corresponding marker to the data stream corresponding to the identification information.

In another specific implementation manner of this embodiment, the processing manner includes a processing policy and a processing parameter that are of the data stream, and the path information includes information about an entry node EN and a function node FN that the data stream needs to pass through; and

the processor is specifically configured to send, to the entry node EN, the information about the function node FN that the data stream needs to pass through, so that the EN adds a corresponding marker to the data stream corresponding to the identification information, and send the processing policy and the processing parameter that are of the data stream to the FN that the data stream needs to pass through, so that the FN processes the data stream corresponding to the identification information.

Alternatively, in still another specific implementation manner of this embodiment, the processing manner includes a processing policy and a processing parameter that are of the data stream, and the path information includes information about a function node FN that the data stream needs to pass through; and

the processor is specifically configured to send the path information, the processing policy, and the processing parameter that are of the data stream to function nodes FN in the path information, so that the FNs process the data stream corresponding to the identification information.

In a preferred implementation manner of this embodiment, the memory is further configured to store the identification information of the data stream, the corresponding processing policy and the corresponding processing parameter.

The network control device provided in this embodiment applies to the communications network provided in embodiments of the present invention, and may be a network controller NC on the communications network provided in FIG. 1. For functions of parts of the network control device and a specific execution process of the network control device, reference may be made to detailed descriptions in embodiments of network control methods provided in the present invention.

By means of the network control device provided in this embodiment, the network control device receives, in a centralized manner, a decision request, and determines a processing manner and path information that are of a data stream according to processing capability information of a node on a network, to control processing nodes, which are indicated by the path information, to process the data stream according to the processing manner, which can optimize a data stream processing procedure to the greatest extent, enhance flexibility of the network, and increase network resource utilization.

FIG. 3 is a schematic structural diagram of a network marking device according to an embodiment of the present invention. As shown in FIG. 3, the network marking device 300 includes: a processor 301, a memory 302, and at least one communications port 303.

The communications port 303 is configured to communicate with an external device; the memory 302 is configured to store a computer program instruction; and the processor 301 is coupled to the memory 302, and is configured to invoke the computer program instruction stored in the memory 302, so as to add, according to received identification information, which is sent by a network control device, of a data stream, and a processing manner and path information that are of the data stream corresponding to the identification information, a corresponding marker to the data stream, and to send marked data.

In a specific implementation manner of this embodiment, the processor 301 is specifically configured to:

add, according to the received identification information, which is sent by the network control device, of the data stream, information about a network processing device that the data stream needs to pass through, a corresponding processing policy and a corresponding processing parameter, a corresponding marker to the data stream corresponding to the identification information, and send the marked data stream.

In another specific implementation manner of this embodiment, the memory 302 is further configured to:

store the identification information of the data stream, information about a function node FN that the data stream needs to pass through, the processing policy, and the processing parameter.

In still another specific implementation manner of this embodiment, the processor 301 is specifically configured to:

add, according to the received identification information, which is sent by the network control device, of the data stream, and information about a function node FN that the data stream needs to pass through, a corresponding marker to the data stream corresponding to the identification information, and send the marked data stream.

In yet another specific implementation manner of this embodiment, the memory 302 is further configured to:

store the identification information of the data stream, and the information about the function node FN that needs to be passed through.

In still another specific implementation manner of this embodiment, the processor 301 is further configured to:

receive a data stream, where the data stream carries identification information of the data stream;

query whether information about a network processing device that the data stream corresponding to the identification information needs to pass through of the data stream is stored in the memory; and

if not, send a decision request to the network control device, where the decision request carries the identification information of the data stream.

Specifically, in the foregoing embodiments, the processor 301 is specifically configured to encapsulate one of or a combination of the path information and the processing manner in a first data packet of the data stream.

Alternatively, in the foregoing embodiments, the processor 301 is specifically configured to encapsulate the one of or combination of the path information and the processing manner in a null data packet, and before sending the data stream, first send the data packet in which the one of or combination of the path information and the processing manner is encapsulated.

In a preferable implementation manner, the processor 301 is further configured to set, to a highest priority, the data packet in which the one of or combination of the path information and the processing manner is encapsulated.

The network marking device provided in this embodiment applies to the communications network provided in embodiments of the present invention, and may be specifically an entry node EN on the communications network shown in FIG. 1. For functions of parts of the network marking device and a specific execution process of the network marking device, reference may be made to detailed descriptions in embodiments of a communications network control method provided in the following embodiments of the present invention. Details are not described herein again.

By means of the network marking device provided in this embodiment, the network marking device performs, according to a received processing manner and received path information that are of a data stream and that are sent by a network control device, marking processing on the data stream, so that function nodes process the data stream according to a marker, which can optimize a data stream processing procedure to the greatest extent, enhance flexibility of the network, and increase network resource utilization.

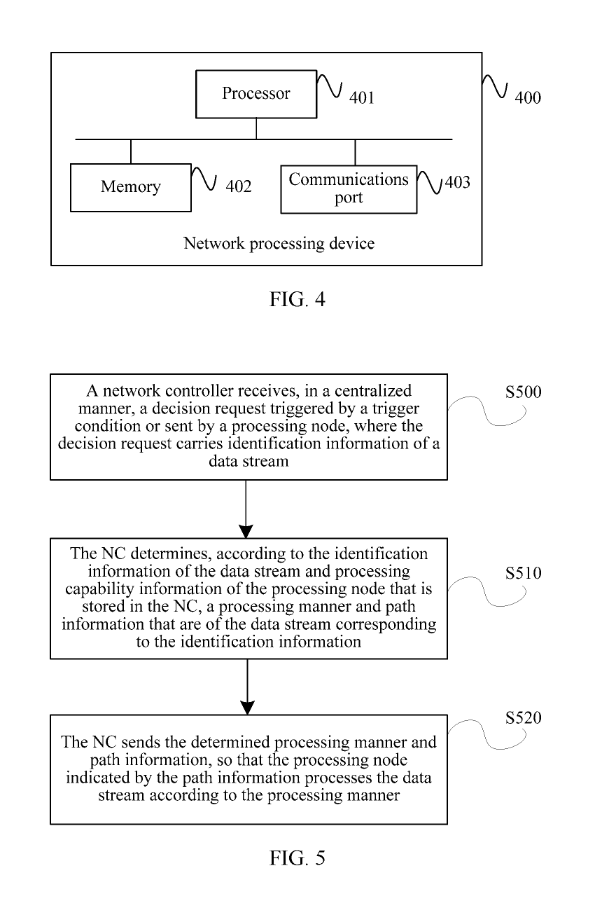

FIG. 4 is a schematic structural diagram of an embodiment of a network processing device according to an embodiment of the present invention. As shown in FIG. 4, the network processing device 400 includes: a processor 401, a memory 402, and at least one communications port 403.

The communications port 403 is configured to communicate with an external device; the memory 402 is configured to store a computer program instruction; the processor 401 is coupled to the memory, and is configured to invoke the computer program instruction stored in the memory, so as to extract, from a marked data stream, a processing policy and a processing parameter that correspond to information about the network processing device, or so as to receive identification information, which is sent by a network control device, of a data stream, a corresponding processing policy and a corresponding processing parameter, and to process the data stream according to the processing policy and the processing parameter; and the memory 402 is further configured to store the identification information of the data stream, the corresponding processing policy and the corresponding processing parameter.

In a specific implementation manner of this embodiment, the processor 401 is further configured to:

receive a data stream, where the data stream carries identification information of the data stream;

query whether a processing manner of the data stream corresponding to the identification information of the data stream is stored in the memory; and

if not, send a decision request to the network control device, where the decision request carries the identification information of the data stream.

The network processing device provided in this embodiment applies to the communications network provided in embodiments of the present invention, and may be specifically a function node FN on the communications network provided in FIG. 1 of the present invention. For specific functions of parts of the network processing device and a specific execution process of the network processing device, reference may be made to detailed descriptions in embodiments of a communications network control method provided in the following embodiments of the present invention. Details are not described herein again.

By means of the network processing device provided in this embodiment, the network processing device processes a corresponding data stream according to an acquired processing policy and processing parameter that are of the data stream, so that a network control device can perform centralized decision processing on a data stream according to processing capabilities of nodes on a network, which can optimize a data stream processing procedure to the greatest extent, enhance flexibility of the network, and increase network resource utilization.

FIG. 5 is a schematic flowchart of Embodiment 1 of a communications network control method according to an embodiment of the present invention. As shown in FIG. 5, the method includes:

S500: A network controller (NC for short) receives, in a centralized manner, a decision request triggered by a trigger condition or sent by a processing node, where the decision request carries identification information of a data stream.

The decision request in this embodiment may be sent by an entry node EN in SDN, or may be sent by a function node FN in SDN, or may be sent by user equipment in SDN, which is not limited in this embodiment. The decision request may be a decision request that is directly sent by an EN, an FN, or user equipment to an NC, or may be a decision request determined by an NC according to a triggered event after receiving the event triggered by an EN, an FN, or user equipment, which is not limited in this embodiment. For example, the triggered event may be service creation, user access, policy change, or user movement.

The identification information of the data stream may be based on user granularity or based on service granularity. For example, if the decision request is for user access, policy change, or user movement, the identification information of the data stream carried in the decision request is based on the user granularity. If the decision request is for service creation, the identification information of the data stream carried in the decision request is based on the service granularity. If the identification information of the data stream carried in the decision request is based on the user granularity, the identification information of the data stream may include a user ID or a user IP address. If the identification information of the data stream carried in the decision request is based on a service granularity, the identification information of the data stream may include a combination of a user ID and a service identifier, or a combination of a user IP address and a service identifier, which is not limited in this embodiment.

S510: The NC determines, according to the identification information of the data stream and processing capability information of the processing node that is stored in the NC, a processing manner and path information that are of the data stream corresponding to the identification information.

A processing capability of a node refers to a calculation capability of an entry node and/or a function node, remaining bandwidth between nodes, a remaining storage capability of a node, or the like.

S520: The NC sends the determined processing manner and path information, so that the processing node indicated by the path information processes the data stream according to the processing manner.

The communications network control method provided in this embodiment applies to a data stream processing and control method on a communications network provided in embodiments of the present invention.

By means of a communications network control method provided in this embodiment, an NC receives, in a centralized manner, a decision request, determines, in the centralized manner, a processing manner and path information that are of a data stream according to processing capabilities of processing nodes on the communications network, and controls, in the centralized manner, an entry node and/or a function node to process data, which can optimize a data stream processing procedure to the greatest extent, enhance flexibility of the network, and increase network resource utilization.

In a possible implementation manner of this embodiment, the processing manner includes a processing policy and a processing parameter, and the path information includes information about the entry node EN and information about a function node FN that the data stream needs to pass through; and

S520 specifically includes: sending, by the NC, the information about the function node FN that the data stream corresponding to the identification information needs to pass through, the processing policy, and the processing parameter to the entry node EN.

Accordingly, after receiving the data stream corresponding to the identification information of the data stream, the EN may process the data stream according to the processing manner and the path information that are sent by the NC. Specifically, the entry node EN adds a corresponding marker to the data stream according to the information about the function node FN that the data stream needs to pass through, the processing policy, and the processing parameter.

After the EN sends the marked data stream, the function node FN may acquire the processing policy and the processing parameter from the data stream after receiving the marked data stream. Specifically, the FN extracts, from the marked data stream, the processing policy and the processing parameter that correspond to the information about the FN, and processes the data stream according to the processing policy and the processing parameter.

For example, when the decision request in S500 is sent by an entry node, an NC determines a processing manner and path information according to identification information of a data stream and stored node processing capability information. The path information, that is, each function node that is passed through, in SDN, by the data stream. The processing manner includes a processing policy and a processing parameter, that is, a policy and a parameter for each function node that is passed through by the data stream to process the data stream. The NC may directly send the processing manner and the path information to the entry node. It should be noted that, when the decision request is directly sent by user equipment on a network, the NC may also directly send the processing manner to the determined entry node, so that the entry node performs path marking on the received data stream corresponding to the identification information of the data stream.

In another possible implementation manner of this embodiment, the processing manner includes a processing policy and a processing parameter that are of the data stream, and the path information includes information about an entry node EN and a function node FN that the data stream needs to pass through; and

the sending, by the NC, the processing manner and the path information specifically includes:

sending, by the NC, to the entry node EN, the information about the function node FN that the data stream needs to pass through; and

sending, by the NC, the processing policy and the processing parameter that are of the data stream to the FN that the data stream needs to pass through.

Accordingly, the entry node receives only the path information of the data stream, and therefore when receiving the data stream corresponding to the identification information of the data stream, the entry node may perform the following operation: adding, by the entry node EN, a corresponding marker to the data stream according to the information about the function node FN that needs to be passed through. That is, the entry node marks only each function node that the data stream needs to pass through. After each function node receives the data stream, if the function node finds that node information of the function node is marked in the data stream, the function node processes the data stream according to the processing policy and the processing parameter; or if the node information does not exist in the data stream, the function node does not process the data stream. Alternatively, after completing the processing on the data stream, a former function node directly sends the data stream to a latter function node according to the marked path information. In this case, the function node that receives the data stream does not need to determine whether the data stream includes information about the current node, and needs only to directly process the data stream according to the processing policy and the processing parameter that correspond to the identification information of the data stream, which is not limited in this embodiment.

For example, after receiving a decision request sent by an EN, an NC may send path information to the entry node, so that the entry node performs path marking on a received data stream, and sends a processing manner, that is, a processing policy and a processing parameter that are of each function node, to each function node, so that the function node processes received data.

In a preferred implementation manner of the foregoing implementation manners, the EN locally stores the identification information of the data stream, and one of or a combination of the corresponding processing manner and the corresponding path information.

Generally, the EN may locally store the received processing manner and path information by using the identification information of the data stream as an index. When receiving a new data stream, the EN queries whether locally there is a corresponding processing manner and corresponding path information according to identification information of the data stream. If not, the EN may send a decision request to the NC, so as to obtain the processing manner and the path information that correspond to the identification information of the data stream.

In still another implementation manner of this embodiment, the processing manner includes a processing policy and a processing parameter that are of the data stream, and the path information includes information about a function node FN that the data stream needs to pass through; and

the sending, by the NC, the processing manner and the path information specifically includes:

sending, by the NC, the path information, the processing policy, and the processing parameter that are of the data stream to function nodes FN in the path information.

For example, if in a process in which an NC delivers a processing policy and a processing parameter, or after an EN marks to-be-processed data, an FN does not receive a corresponding processing policy and processing parameter due to some reasons, after receiving a data stream, the FN may also directly send a decision request to the NC. In this case, the NC may determine, according to only identification information of the data stream and processing capability information of the FN that sends the decision request, a processing policy and a processing parameter for the FN to process the to-be-processed data, and send the determined processing policy and processing parameter to the FN that sends the decision request.

In a preferred implementation manner in the foregoing embodiments, the FN locally stores the identification information of the data stream, and the corresponding processing manner.

For to-be-processed data with a same user identifier and/or same service information, a same FN has a same processing policy and a same processing parameter. Therefore, the FN may locally store the received processing policy and processing parameter by using the identification information of the data stream as an index; and for a data stream with the same identification information of the data stream, the NC may not perform decision processing repetitively, and the FN may process to-be-processed data according to the processing policy and processing parameter that are stored locally.

Specifically, the adding, by the EN, the corresponding marker to the data stream specifically includes:

adding, by the EN, the corresponding marker to a first data packet of the data stream; or adding, by the EN, the corresponding marker to a null data packet, and before sending the data stream, first sending the data packet to which the corresponding marker is added.

The data stream may be transferred on a data path in a source routing or per-hop routing manner. For example, after receiving a data stream corresponding to identification information of the data stream, an entry node adds, to a first data packet or another null data packet of the data stream, information about a function node FN that the data stream needs to pass through, a processing policy, and a processing parameter, that is, marks, in the data packet, an identifier of a function node of each hop on a data stream path, a corresponding processing policy and a corresponding processing parameter. The marking may be performed in a manner in the following table.

| | | | |
|---|---|---|---|
| Hop1: Policy:param | Hop2: Policy:param | . . . | Hop3: Policy:param |

Hop1 is an identifier of a function node of the first hop, Hop2 is an identifier of a function node of the second hop, and Hop3 is an identifier of a function node of the third hop. The EN may route a subsequent data stream to an FN of the first hop according to Hop1, the FN of the first hop (that is, the FN marked with Hop1) may route the data stream to an FN of the second hop according to Hop2, and so on. Policy is a processing policy corresponding to an identifier of a function node, and param is a processing parameter corresponding to the identifier of the function node. It should be noted that, the foregoing description about the manner for marking a processing manner is only exemplary description, and is not a limited definition. In addition, to enable the FN to

Further, the method further includes: setting, by the EN, to a highest priority, the data packet to which the corresponding marker is added.

A first data packet or a null data packet in which a processing manner is marked is very important, and therefore if the first data packet or the null data packet is lost, a relatively major fault is caused in a system. Therefore, the data packet should be set to a highest priority, to prevent a packet loss.

In a preferred implementation manner of this embodiment, before the sending, by the NC, the processing manner and the path information, the method further includes:

locally storing, by the NC, the identification information of the data stream, the corresponding processing manner and the corresponding path information.

Generally, when receiving a new decision request, the NC may query, according to the identification information of the data stream, for the processing manner and the path information that are locally stored. If the corresponding processing manner and path information are found, the NC may directly send the found processing manner and path information to a corresponding EN and/or FN. If the corresponding processing manner and path information are not found, the NC determines, according to the decision request, a processing manner and path information that correspond to a data stream identifier of the to-be-processed data. The NC may further often update, according to a need, information that is locally stored, such as a processing policy and a processing parameter.

In still another possible implementation manner of this embodiment, the method further includes: receiving, by the EN, a data stream, where the data stream carries identification information of the data stream;

querying, by the EN, whether path information of the data stream corresponding to the identification information of the data stream is stored locally; and

if not, sending, by the EN, a decision request to the NC, where the decision request carries the identification information of the data stream.

In yet another possible implementation manner of this embodiment, the method further includes: receiving, by the FN, a data stream, where the data stream carries identification information of the data stream;

querying, by the FN, whether a processing manner of the data stream corresponding to the identification information of the data stream is stored locally; and

if not, sending, by the FN, a decision request to the NC, where the decision request carries the identification information of the data stream.

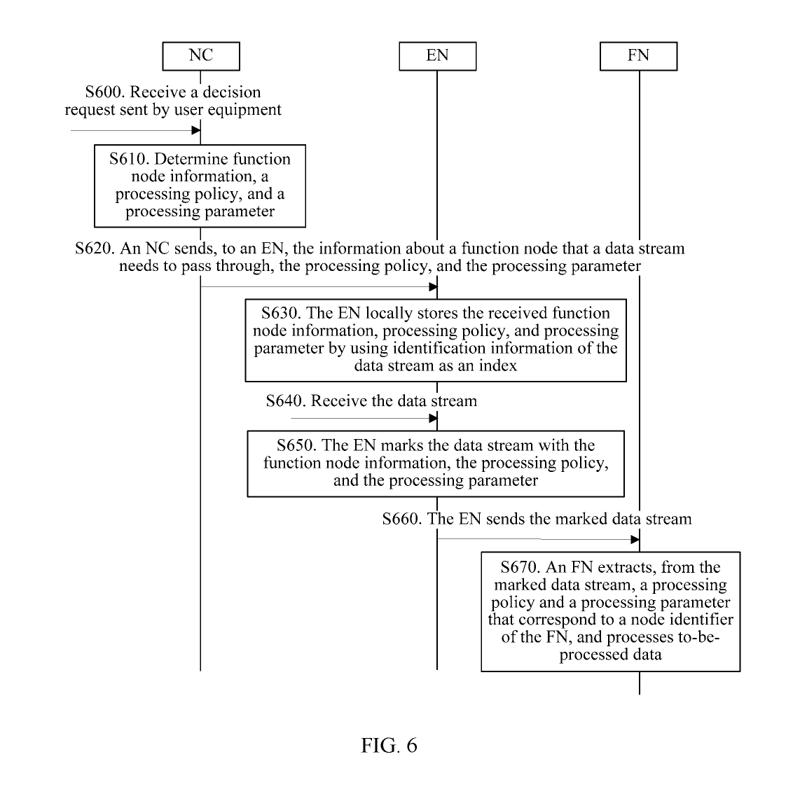

FIG. 6 is a schematic flowchart of Embodiment 2 of a communications network control method according to an embodiment of the present invention. As shown in FIG. 6, this embodiment provides a specific embodiment in which user equipment sends a decision request to an NC, and the NC sends a processing manner to an EN, that is, a processing policy and a processing parameter are carried in a source route so to be transferred to a corresponding node. A processing policy and a processing parameter that are determined by the NC are both delivered to the entry node. The EN adds the processing policy and the processing parameter to a first packet of to-be-processed data, and notifies, in an associated manner, an execution body, that is, each FN on a data stream processing path, of the processing policy and the processing parameter. If subsequently the processing policy or the processing parameter changes, a notification is still performed in the associated manner by using a data packet. Advantages of this manner are that a network operation is simple, and there is a relatively small quantity of requirements on each FN. However, disadvantages are that a requirement on the EN is relatively high, a processing speed may be affected, and a relatively major fault is caused in case of a packet loss. Therefore, in this embodiment, a data packet having a policy and a parameter needs to have a highest priority, to prevent the packet loss. The method includes:

S600: The NC receives a decision request sent by the user equipment.

S610: The NC determines function node information, a processing policy, and a processing parameter.

S620: The NC sends, to the EN, the information about a function node that a data stream needs to pass through, the processing policy, and the processing parameter.

S630: The EN locally stores the received function node information, processing policy, and processing parameter by using identification information of the data stream as an index.

S640: The EN receives the data stream.

S650: The EN marks the data stream with the function node information, the processing policy, and the processing parameter.

S660: The EN sends the marked data stream.

S670: An FN extracts, from the marked data stream, a processing policy and a processing parameter that correspond to a node identifier of the FN, and processes to-be-processed data.

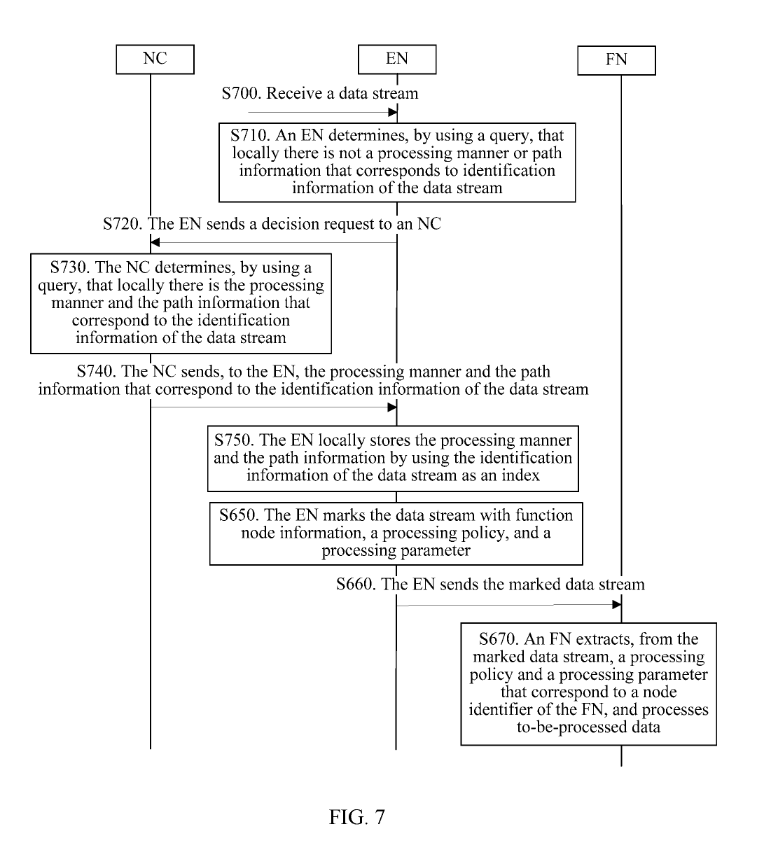

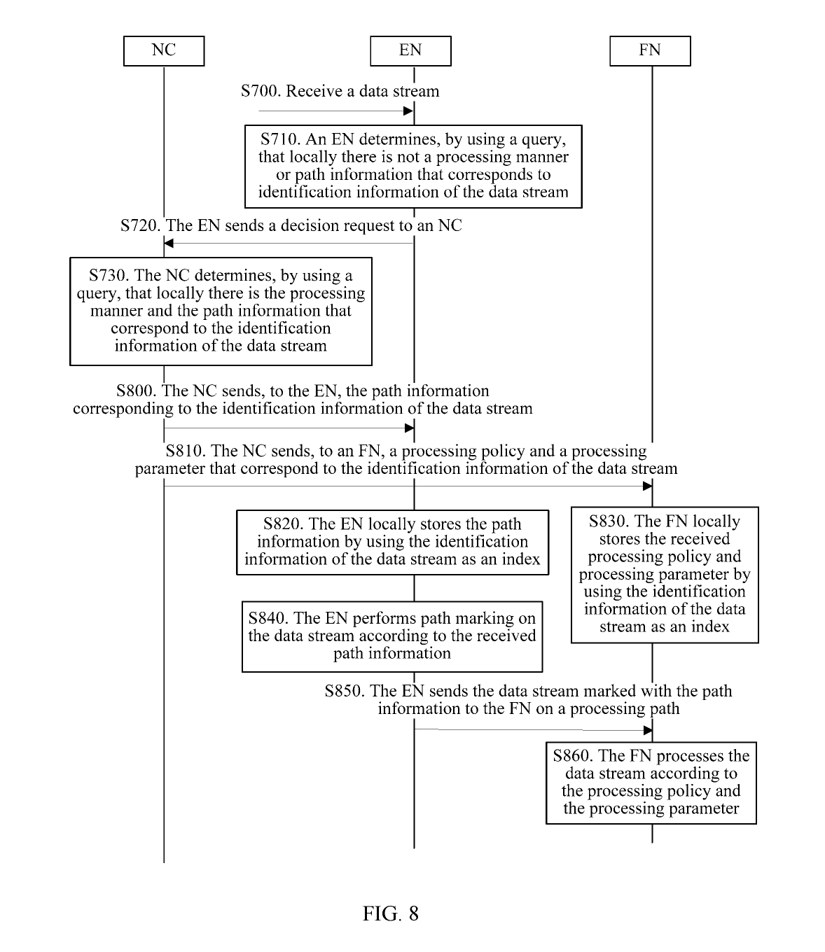

FIG. 7 is a schematic flowchart of Embodiment 3 of a communications network control method according to an embodiment of the present invention. As shown in FIG. 7, this embodiment provides a specific embodiment in which an EN sends a decision request to an NC, and the NC sends a processing manner to the EN. A difference from Embodiment 3 is that, before S650 in the foregoing method, the method includes:

S700: The EN receives a data stream.

S710: The EN determines, by using a query, that locally there is not a processing manner or path information that corresponds to identification information of the data stream.

S720: The EN sends a decision request to the NC.

S730: The NC determines, by using a query, that locally there is the processing manner and the path information that correspond to the identification information of the data stream.

S740: The NC sends, to the EN, the processing manner and the path information that correspond to the identification information of the data stream.

S750: The EN locally stores the processing manner and the path information by using the identification information of the data stream as an index.

FIG. 8 is a schematic flowchart of Embodiment 4 of a communications network control method according to an embodiment of the present invention. As shown in FIG. 8, this embodiment provides a specific embodiment in which an EN sends a decision request to an NC, and the NC sends path information to the EN and sends a processing policy and a processing parameter to an FN. A difference from the method provided in FIG. 3 is that, after S730, the method includes:

S800: The NC sends, to the EN, path information corresponding to identification information of a data stream.

S810: The NC sends, to the FN, a processing policy and a processing parameter that correspond to the identification information of the data stream.

S820: The EN locally stores the path information by using the identification information of the data stream as an index.

S830: The FN locally stores the received processing policy and processing parameter by using the identification information of the data stream as an index.

S840: The EN performs path marking on the data stream according to the received path information.

S850: The EN sends the data stream marked with the path information to the FN on a processing path.

S860: The FN processes the data stream according to the processing policy and the processing parameter.

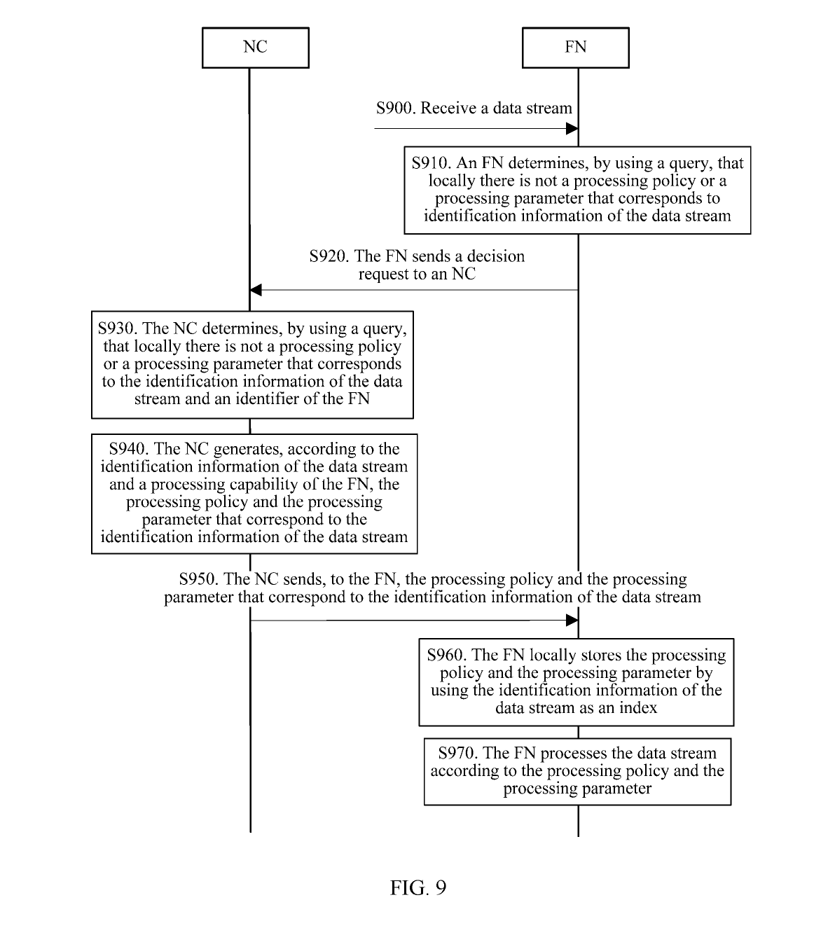

FIG. 9 is a schematic flowchart of Embodiment 5 of a communications network control method according to an embodiment of the present invention. As shown in FIG. 9, this embodiment provides a specific embodiment in which an FN sends a decision request to an NC, and the NC sends a processing manner to the FN. The method includes:

S900: The FN receives a data stream.

S910: The FN determines, by using a query, that locally there is not a processing policy or a processing parameter that corresponds to identification information of the data stream.

S920: The FN sends a decision request to the NC.

S930: The NC determines, by using a query, that locally there is not a processing policy or a processing parameter that corresponds to the identification information of the data stream and an identifier of the FN.

S940: The NC generates, according to the identification information of the data stream and a processing capability of the FN, the processing policy and the processing parameter that correspond to the identification information of the data stream.

S950: The NC sends, to the FN, the processing policy and the processing parameter that correspond to the identification information of the data stream.

S960: The FN locally stores the processing policy and the processing parameter by using the identification information of the data stream as an index.

S970: The FN processes the data stream according to the processing policy and the processing parameter.

It should be noted that, in all of the foregoing embodiments of the present invention, an EN performs path marking on to-be-processed data. A person skilled in the art may understand that, path information may be directly sent to a function node on a data path; for example, a first function node performs path marking or does not perform path marking, and each function node determines a function node of a next hop according to the path information, which is not limited in the present invention.

A person of ordinary skill in the art may understand that all or some of the steps of the method embodiments may be implemented by a program instructing relevant hardware. The program may be stored in a computer readable storage medium. When the program runs, the steps of the method embodiments are performed. The foregoing storage medium includes: any medium that can store program code, such as a ROM, a RAM, a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

1. A communications network, comprising:
a network controller (NC),
at least one entry node (EN), and
at least one function node (FN),
wherein the NC is configured to
receive, in a centralized manner, a decision request triggered by a trigger condition or sent by a processing node, wherein the decision request carries identification information of a data stream,
determine, according to the identification information of the data stream and processing capability information of the processing node that is stored in the NC, a processing manner and path information that are of the data stream corresponding to the identification information, and
send the determined processing manner and path information to the at least one EN and/or the at least one FN; and
wherein the at least one EN and the at least one FN are configured to process the data stream according to the processing manner.

2. The communications network according to claim 1, wherein
the processing manner comprises a processing policy and a processing parameter, and the path information comprises information about the at least one EN and information about one or more FN that the data stream needs to pass through;
wherein the NC is further configured to send the information about the one or more FNs that the data stream needs to pass through, the processing policy, and the processing parameter to the at least one EN;
wherein the at least one EN is further configured to add a corresponding marker to the data stream according to the information about the one or more FNs that the data stream needs to pass through, the processing policy, and the processing parameter, and send out the marked data stream; and
wherein each of the one or more FNs that the data stream needs to pass through are configured to extract, from the marked data stream, a processing policy and a processing parameter corresponding to the respective function node (FN), and process the data stream according to the processing policy and the processing parameter.

3. The communications network according to claim 1, wherein the processing manner comprises a processing policy and a processing parameter that are of the data stream, and the path information comprises information about the at least one EN and information about one or more FNs that the data stream needs to pass through;
wherein the NC is further configured to send, to the at least one EN, the information about the one or more FNs that the data stream needs to pass through, and send the processing policy and the processing parameter that are of the data stream to the FN that the data stream needs to pass through;
wherein the at least one EN is further configured to add a corresponding marker to the data stream according to the information about the one or more FNs that the data stream needs to pass through; and
wherein each of the one or more FNs that the data stream needs to pass through are configured to process, according to the processing policy and the processing parameter, the data stream marked with the information about the one or more FNs that the data stream needs to pass through.

4. The communications network according to claim 1, wherein the processing manner comprises a processing policy and a processing parameter that are of the data stream, and the path information comprises information about one or more FNs that the data stream needs to pass through;
wherein the NC is further configured to send the path information, the processing policy, and the processing parameter that are of the data stream to the one or more FNs that the data stream needs to pass through; and
wherein each of the one or more FNs that the data stream needs to pass through are configured to process the data stream according to the processing policy and the processing parameter.

5. The communications network according to claim 1, wherein the NC is further configured to:
before sending the processing manner and the path information to the at least one EN and/or the at least one EN, locally store the identification information of the data stream, the corresponding processing manner and the corresponding path information.

6. The communications network according to claim 2, wherein the at least one EN is further configured to:
locally store the identification information of the data stream, the information about the one or more FNs that the data stream needs to pass through, the processing policy, and the processing parameter; and
wherein each of the one or more FNs that the data stream needs to pass through are further configured to:
after extracting, from the marked data stream, the processing policy and the processing parameter corresponding to the respective FN, locally store the identification information of the data stream, the corresponding processing policy and the corresponding processing parameter.

7. The communications network according to claim 3, wherein the at least one EN is further configured to:
locally store the identification information of the data stream, the information about the one or more FNs that the data stream needs to pass through; and
wherein each of the one or more FNs that the data stream needs to pass through are further configured to:
locally store the identification information of the data stream, the corresponding processing policy and the corresponding processing parameter.

8. A network control device, comprising:
a processor,
a memory, and
at least one communications port,
wherein the communications port is configured to communicate with an external device;
wherein the memory is configured to store processor-executable instructions; and
wherein the processor is coupled to the memory, and is configured to execute the processor-executable instructions to facilitate:
receiving, in a centralized manner, a decision request triggered by a trigger condition or sent by a processing node, wherein the decision request carries identification information of a data stream,
determining, according to the identification information of the data stream and processing capability information of a node that is stored in the memory, a processing manner and path information that are of the data stream corresponding to the identification information, and
sending the determined processing manner and path information to facilitate the processing node indicated by the path information processing the data stream according to the processing manner.

9. The network control device according to claim 8, wherein the processing manner comprises a processing policy and a processing parameter, and the path information comprises information about an entry node (EN) and information about a function node (FN) that the data stream needs to pass through; and
wherein the processor is further configured to execute the processor-executable instructions to facilitate sending the information about the FN that the data stream needs to pass through, the processing policy, and the processing parameter to the EN to facilitate the EN adding a corresponding marker to the data stream corresponding to the identification information.

10. The network control device according to claim 8, wherein the processing manner comprises a processing policy and a processing parameter that are of the data stream, and the path information comprises information about an entry node (EN) and a function node (FN) that the data stream needs to pass through; and
wherein the processor is further configured to execute the processor-executable instructions to facilitate sending, to the EN, the information about the FN that the data stream needs to pass through to facilitate the EN adding a corresponding marker to the data stream corresponding to the identification information and sending the processing policy and the processing parameter that are of the data stream to the FN that the data stream needs to pass through.

11. The network control device according to claim 8, wherein the processing manner comprises a processing policy and a processing parameter that are of the data stream, and the path information comprises information about a function node (FN) that the data stream needs to pass through; and
wherein the processor is further configured to execute the processor-executable instructions to facilitate sending the path information, the processing policy, and the processing parameter that are of the data stream to the FN that the data stream needs to pass through to facilitate the function FN processing the data stream corresponding to the identification information.

12. A network marking device, comprising:
a processor,
a memory, and
at least one communications port,
wherein the communications port is configured to communicate with an external device;
wherein the memory is configured to store processor-executable instructions; and
wherein the processor is coupled to the memory, and is configured to execute the processor-executable instructions to facilitate:
adding, according to received identification information, which is sent by a network control device, of a data stream, and a processing manner and path information that are of the data stream corresponding to the identification information, a corresponding marker to the data stream, and
sending marked data.

13. The network marking device according to claim 12, wherein the processor is further configured to execute the processor-executable instructions to facilitate:
adding, according to the received identification information, which is sent by the network control device, of the data stream, information about a network processing device that the data stream needs to pass through, a corresponding processing policy and a corresponding processing parameter, and a corresponding marker to the data stream corresponding to the identification information, and
sending the marked data stream.

14. The network marking device according to claim 13, wherein the memory is further configured to:
store the identification information of the data stream, information about a function node (FN) that the data stream needs to pass through, the processing policy, and the processing parameter.

15. The network marking device according to claim 12, wherein the processor is further configured to execute the processor-executable instructions to facilitate:
adding, according to the received identification information, which is sent by the network control device, of the data stream, and information about a function node (FN) that the data stream needs to pass through, a corresponding marker to the data stream corresponding to the identification information, and
sending the marked data stream.

16. The network marking device according to claim 15, wherein the memory is further configured to:
store the identification information of the data stream, and the information about the FN that needs to be passed through.

17. A network processing device, comprising:
a processor,
a memory, and
at least one communications port,
wherein the communications port is configured to communicate with an external device;
wherein the memory is configured to store processor-executable instructions;
wherein the processor is coupled to the memory, and is configured to execute the processor-executable instructions to facilitate:
extracting, from a marked data stream, a processing policy and a processing parameter that correspond to information about the network processing device, or receiving identification information, which is sent by a network control device, of a data stream, a corresponding processing policy and a corresponding processing parameter, and
processing the data stream according to the processing policy and the processing parameter; and
wherein the memory is further configured to store the identification information of the data stream, the corresponding processing policy and the corresponding processing parameter.

18. The network processing device according to claim 17, wherein the processor is further configured to execute the processor-executable instructions to facilitate:
receiving a data stream, wherein the data stream carries identification information of the data stream;
querying whether a processing manner of the data stream corresponding to the identification information of the data stream is stored in the memory; and
if the processing manner of the data stream corresponding to the identification information of the data stream is not stored in the memory, sending a decision request to the network control device, wherein the decision request carries the identification information of the data stream.

19. A communications network control method, comprising:
receiving, by a network controller (NC), in a centralized manner, a decision request triggered by a trigger condition or sent by a processing node, wherein the decision request carries identification information of a data stream;
determining, by the NC according to the identification information of the data stream and processing capability information of the processing node that is stored in the NC, a processing manner and path information that are of the data stream corresponding to the identification information; and
sending, by the NC, the determined processing manner and path information to facilitate the processing node indicated by the path information processing the data stream according to the processing manner.

20. The communications network control method according to claim 19, wherein the processing manner comprises a processing policy and a processing parameter, and the path information comprises information about an entry node LEN) and information about a function node (FN) that the data stream needs to pass through; and
wherein sending the processing manner and the path information further comprises:
sending, by the NC, the information about the FN that the data stream needs to pass through, the processing policy, and the processing parameter to the EN.

21. The communications network control method according to claim 20, wherein the EN adds a corresponding marker to the data stream according to the information about the FN that the data stream needs to pass through, the processing policy, and the processing parameter.

22. The communications network control method according to claim 21, wherein the FN extracts, from the marked data stream, the processing policy and the processing parameter corresponding to the information about the FN, and processes the data stream according to the processing policy and the processing parameter.

23. The communications network control method according to claim 19, wherein the processing manner comprises a processing policy and a processing parameter that are of the data stream, and the path information comprises information about an entry node (EN) and a function node (FN) that the data stream needs to pass through; and
wherein sending the processing manner and the path information further comprises:
sending, by the NC, to the EN, the information about the FN that the data stream needs to pass through; and
sending, by the NC, the processing policy and the processing parameter that are of the data stream to the FN that the data stream needs to pass through.
